(19) United States
(12) Patent Application Publication
(10) Pub. No.: US 2025/0252252 A1
(43) Pub. Date: Aug. 7, 2025

(54) AUTOMATIC FORM FILLING BASED ON DECODED INFORMATION FROM MACHINE-READABLE IDENTIFIER

(71) Applicant: GOOGLE LLC, Mountain View, CA (US)

(72) Inventors: Balachandra Shetty, Bangalore (IN); Vivek Bharadwaj, Bangalore (IN); Shashank Jain, Bangalore (IN); Jeyashankher Ramamirtham, Bangalore (IN); Anand Gokulchandran, Bangalore (IN); Priyanka Sharma, London (GB)

(21) Appl. No.: 18/855,614

(22) PCT Filed: Oct. 7, 2022
(86) PCT No.: PCT/US2022/046065

§ 371 Date: Oct. 9, 2024

(30) Foreign Application Priority Data
Apr. 11, 2022 (IN) 202221021647

(51) Int. Cl. G06F 40/174; G06F 3/0482; G06F 3/0484; G06F 3/16; G06F 40/103; G06K 7/14; G06V 30/413

(52) U.S. Cl. CPC G06F 40/174; G06F 3/167; G06F 40/103; G06K 7/1417; G06V 30/413; G06F 3/0482; G06F 3/0484

(57) ABSTRACT

Implementations relate to processing an image of a machine-read-able identifier (e.g., a QR code or other 2D barcode) to extract information that is encoded in the machine-readable identifier, and using the extracted information in automatically populating input fields of a fillable form that is being rendered at an application (e.g., a web browser application) of a computing device. Some implementations convert certain information, extracted from a machine-readable identifier, to a converted format and cause the converted format information to be populated in a corresponding input field in lieu of the certain information in its raw format that is extracted from the machine-readable identifier.

### BACKGROUND

Machine-readable identifiers include, for example, linear barcodes and matrix (2D) barcodes such as a quick response (“QR”) code, a PDF417 code, a DataCode, and Just Another Bar (JAB) code. Information can be encoded in a machine-readable identifier, and that information can later be extracted based on processing of an image of that machine-readable identifier. The information that is encoded in a machine-readable identifier can be in a machine-readable form, such that a human cannot readily extract information without employing a separate electronic device. For example, a human viewing a QR code and without the assistance of any separate computing device, can be unable to ascertain any of the information that is encoded by the QR code. However, an application of a computing device (e.g., a smartphone) can be used to process image data that captures the QR code (e.g., image data from a camera stream of a camera of the smartphone), and can efficiently decode the encoded information from the QR code.

Separately, various techniques have been utilized in automatically filling in electronic fillable forms, such as a fillable form of a webpage or a fillable form integrated into content of a computer application. Some of those techniques store data that has been previously manually input by a user into a fillable form (e.g., by typing it using a manual or virtual keyboard), and subsequently use the stored data in attempting to automatically inject or submit that stored data into corresponding input field(s) of subsequently encountered fillable forms.

However, such techniques can require that a user previously manually input the corresponding data, which can be difficult or impossible for various users such as those with limited dexterity, those with limited literacy, and/or those that are not technologically savvy. Such techniques also fail to work for certain data when the certain data has not been previously manually input by a corresponding user and/or at a corresponding electronic device. For example, a “birthdate” field, in a fillable form, may not be able to be automatically filled for a user as a result of the user having never before manually input their birthdate in prior fillable form(s). Further, such techniques require data to be stored in non-transitory storage for later utilization, which can present security concerns for certain data. Yet further, such techniques often store multiple different sets of data at or in association with a computing device and/or in association with a user account. This can result in the incorrect set of data being inadvertently filled into input fields of a fillable form document rendered at the computing device (which can require waste of computational resources to manually edit) and/or can result in the incorrect set of data being inadvertently submitted after filling into the input fields of the fillable form document (which can require waste of computational resources to remedy). For example, a shared computing device can store a first set of data for a first user and a second set of data for a second user. The second set of data can erroneously be utilized in filling input fields of a fillable form document, despite the first user being the one utilizing the shared computing device and intending to fill the fillable form document with the first set of data.

Additional and/or alternative drawbacks are present for various form filling techniques, and can prevent many users (e.g., those who have limited dexterity and/or limited literacy) from being able to successfully populate fillable form documents and/or can prolong the duration of time needed to successfully populate and submit fillable form documents, which can consume resources of a corresponding computing device being used to render and populate the fillable form document.

### SUMMARY

Implementations set forth herein relate to processing an image of a machine-readable identifier (e.g., a QR code or other 2D barcode) to extract information that is encoded in the machine-readable identifier, and using the extracted information in automatically populating input fields of a fillable form that is being rendered at an application (e.g., a web browser application) of a computing device.

In some implementations, in response to determining that a computing device is rendering a fillable form document, a prompt can be caused to be rendered at the application or at a separate application (e.g., an automated assistant application) of the computing device. Determining that the application is rendering the fillable form document can be based on, for example, determining that markup language (e.g., HyperText Markup Language (HTML) or Extensible Markup Language (XML)) for the document indicates presence of a fillable form and/or determining that a Uniform Resource Identifier (URI) for the document is pre-indexed with an indication that it includes a fillable form.

The rendered prompt can visually and/or audibly solicit that a user cause image data to be provided that captures a machine-readable identifier of an informational document (e.g., an identification card issued by a governmental entity) in order that information can be extracted, from the machine-readable identifier in the image data, for use in automatically populating input field(s) of the rendered fillable form document. For example, the prompt can solicit that the user authorize access to a stream from a camera of the computing device and/or can solicit that the user direct the camera toward a QR code of an identification card of the user. Image data, from the stream and that captures the QR code, can be processed to extract information from the QR code. As another example, the prompt can additionally or alternatively solicit that the user authorize access to a previously captured image of at least the QR code of the identification card. The previously captured image can be one saved at the computing device or one saved in cloud storage but accessible at the computing device. Responsive to affirmative user interface input being received responsive to the prompt, the previously captured image can be identified (optionally with assistive input(s) from the user), and image data from the previously captured image used to extract the information. Extracted information, from a machine-readable identifier captured in image data, can then be used in automatically populating at least some of the input fields of the fillable form document. For example, the extracted information can include a surname of the user that is used to populate a “last name” input field. As another example, the extracted information can include a birthdate of the user that is in MM/DD/YYYY format. The birthdate in the MM/DD/YYYY format can be converted to a DD-MM-YYYY format, and the converted format DD-MM-YYYY data used to populate a “date of birth” input field that only accepts data in the DD-MM-YYYY format.

As referenced above, some implementations convert certain information, extracted from a machine-readable identifier, to a converted format and cause the converted format information to be populated in a corresponding input field in lieu of the certain information in its raw format as extracted from the machine-readable identifier. The converted format information is in a format that conforms to an acceptable format for the corresponding input field, whereas the raw format is not. Providing the converted format information, in lieu of the raw format information, can prevent provision of error prompt(s), by the fillable form document, such as a proactive error prompt (prior to attempted submission of the form) or a reactive error prompt (provided in response to an attempted submission of the form). This can conserve computational resources by obviating the need for a user to manually alter the format if the raw format information were instead provided. Further, users with limited literacy may be unable to understand the error prompts and/or users that have dexterity limitations may be unable to effectively alter the format. Providing the converted format information can remedy those issues.

In some of the implementations that convert certain extracted information to a converted format, one or more techniques can be utilized to enable the conversion to be performed with reduced latency, to ensure accuracy of the conversion, and/or to enable reduced latency population of converted format information into the correct input field of the fillable form document. Some of those implementations utilize regular expression(s) to convert raw format information into converted format counterpart(s). For example: a first regular expression can be used to convert raw date information, that is in MM/DD/YYYY format, to converted date information that is in DD/MM/YY format; a second regular expression can be used to convert raw name information that is in First, Middle, Last format, to converted name information that is in Last, First, Middle Initial format; etc. Using regular expression(s) can enable efficient conversion at a computing device rendering the fillable form, thereby preventing the need to transmit any of the information, from the computing device to remote server(s) for conversion of the information at the remote server(s). In addition to conserving network resources by preventing transmission of the information, security of the information is ensured by maintaining the information on the computing device without transmission of the information to any remote server(s). For example, information obtained by scanning a QR code can be maintained on a client computing device and encrypted to prevent misappropriation.

Some of those implementations can, in converting extracted information to a converted format, identify the regular expression(s) and/or other conversion technique(s) to utilize in dependence on the fillable form that is being rendered and/or in dependence on the machine-readable identifier from which the information is extracted. For example, some implementations can utilize a particular set of regular expression(s), for converting extracted information, based on the particular set being pre-indexed in association with the fillable form (e.g., with a URI or other identifier of the fillable form) and/or pre-indexed in association with the machine-readable identifier from which the information is extracted (e.g., pre-indexed in association with a corresponding type of information document on which the machine-readable identifier is provided). For instance, prior to a fillable form of a webpage being rendered at a given computing device when the webpage is accessed, one or more server computing devices can analyze the webpage to determine appropriate format(s) for input field(s) of the fillable form and determine, for each of one or more informational documents, regular expression(s) that can be utilized to convert extracted information (in corresponding raw format) from a machine-readable identifier of the informational document, to the appropriate format(s).

When the fillable form is subsequently rendered at the given computing device, an identifier of the fillable form and, optionally, an identifier of the machine-readable identifier from which information is extracted, can be used to quickly identify regular expression(s) indexed therewith. For instance, the given computing device can transmit, to the server computing device(s), a URI of a document that is being rendered and that includes the fillable form. The server computing device(s) can use the URI to identify the regular expression(s) indexed with the URI, and transmit the regular expression(s) to the computing device. The computing device can receive the transmitted regular expression(s) and utilize those regular expression(s) in converting raw format information to the converted format. In these and other manners, the computing device can obtain the regular expression(s) without needing to process the fillable form itself, and can utilize the regular expression(s) to efficiently convert the raw format information into appropriately formatted converted information, and utilize the converted information in filling corresponding input field(s). Accordingly, certain processing of the fillable form by the given computing device and additional computing devices that render other instances of the fillable form is obviated. In addition to conserving computational resources by obviating the certain processing, the pre-indexing of the regular expressions can enable the regular expressions to be determined more quickly, thereby reducing latency of generating the converted format information, and its incorporation into input field(s) of the fillable form.

As one particular example, assume a fillable form of URI #1, a first type of identification card (ID) (e.g., an Aadhaar card of India and/or any other ID card), and a second type of identification card (e.g., a Permanent Account Number (PAN) card of India and/or any other ID card). Further assume that extracted information from any QR code of the first type of identification card is in a first raw format (e.g., an extracted “name” will be in a “First, Middle, Last” raw format and an extracted “birthdate” will be in a “MM/DD/YYYY” format). Yet further, assume that extracted information from any QR code of the second type of identification card is in a second raw format (e.g., an extracted “name” will be in a “Last, First, Middle” raw format and an extracted birthdate will be in a “DD/MM/YYYY” format). A first set of regular expressions can be pre-indexed with URI #1 and the first type of identification card and a second set of regular expressions can be pre-indexed with URI #1 and the second type of identification card. The first set of regular expressions and the second set of regular expressions can differ. For example, the first set can include regular expression(s) that are not included in the second set and/or can lack regular expression(s) that are included in the first set.

The first set of regular expressions can be used by a computing device when URI #1 is being accessed and image data, that captures a corresponding QR code from the first type of identification card, is used to extract information from the corresponding QR code. The first set of regular expressions is used based on the first set being indexed in association with URI #1 and in association with the first type of identification card. On the other hand, the second set of regular expressions can be used by a computing device when URI #1 is being accessed and image data, that captures a corresponding QR code from the second type of identification card, is used to extract information from the corresponding QR code. The second set of regular expressions is used based on the second set being indexed in association with URI #1 and in association with the second type of identification card. In some implementations, the first set, the second set, and their corresponding associations can be provided to the computing device (e.g., by a remote server system) in response to the computing device accessing URI #1 (e.g., provided responsive to a request, from the computing device, that indicates URI #1). The computing device can then determine to utilize either the first set or the second set in dependence on whether a user causes image data for the first type of identification card to be provided or, instead, causes image data for the second type of identification card to be provided. In some other implementations, only the first set or only the second set is provided to the computing device, in response to the computing device providing a request that indicates URI #1 and that also indicates which type of identification card is being utilized.

In some implementations, information population rule(s) and/or information prompting data can additionally or alternatively be pre-indexed in association with a URI, or other identifier of a fillable form and, optionally, in association with a type of identification card. The information population rule(s) can dictate how to populate input fields of a fillable form with information (raw or converted) extracted from a QR code. For example, for URI #1 and a first type of information card, the information population rules can dictate that extracted raw name information is to be populated in a first input field, that converted birthdate information is to be populated in a second input field, etc. As another example, for URI #1 and a second type of information card, the information population rules can dictate that converted name information is to be populated in the first input field, that raw birthdate information is to be populated in a second field, etc. The information prompting data can dictate how to prompt for value(s) for input field(s) of a fillable form that are not able to be filled based on information extracted from a QR code. For example, for URI #1 and a first type of information card, the information prompting data can dictate that audible and/or visual prompt(s) be provided for a “time” input field and for a “Permanent Account Number” input field, based on information for those fields not being included in the information extractable from a QR code for the first type of information card. For URI #1 and a second type of information card, the information prompting data can dictate that audible and/or visual prompt(s) be provided for a “time” input field based on information for that field not being included in the information extractable from a QR code for the second type of information card. However, the information prompting data for URI #1 and the second type of information card will not dictate that prompt(s) be provided for a “Permanent Account Number” input field, based on information for that field being included in the information extractable from a QR code for the second type of information card.

In these and other manners, a computing device can obtain the information population rule(s) and/or information prompting data for a fillable form without needing to process the fillable form itself, and can utilize the information population rule(s) in filling corresponding input field(s) and/or information prompting data in obtaining further information for filling other corresponding input field(s). Accordingly, certain processing of the fillable form by the computing device and additional computing devices that render other instances of the fillable form is obviated. In addition to conserving computational resources by obviating the certain processing, the pre-indexing of the information population rule(s) and/or information prompting data can enable the information population rule(s) and/or information prompting data to be determined more quickly, thereby reducing latency of incorporating information into input field(s) of the fillable form.

As referenced above, some implementations disclosed herein extract information from a machine-readable identifier in dependence on a type of identification card on which the machine-readable identifier is included, determine how to convert extracted information in dependence on the type of identification card, and/or determine information population rule(s) and/or information prompting data in dependence on the type of identification card. In some versions of those implementations, the type of identification card can be determined based on processing image data that captures at least the machine-readable identifier of an information card. In some of those versions, the type can be determined based on feature(s), of the machine-readable identifier, that are captured in the image data and that are determined based on the processing. For example, a QR code in image data can have feature(s) that indicate it is included on a first type of identification card. For instance, the extracted information itself, extracted from the QR code, can directly indicate that the QR code is included on the first type of identification card (e.g., the extracted information includes a particular type of information, or a particular combination of types of information, that are encoded only in QR code(s) on the first type). In some of those versions, the type is additionally or alternatively determined based on external feature(s), that are captured in the image data and that are feature(s) of the identification card—but that are external to the machine-readable identifier itself. For example, certain color(s), text, and/or symbol(s) that are on a given identification card and that are external to the machine-readable identifier, can indicate that the given identification card is a second type of identification card. Using the external feature(s) can be beneficial, for example, in situations where processing of the machine-readable identifier itself does not always unambiguously identify the type of identification card on which the machine-readable identifier is provided.

In these and other manners, the type of identification card being utilized can be determined, and that determination used in determining how to extract information from a corresponding machine-readable identifier, determining how to convert extracted information, and/or in determining information population rule(s) and/or information prompting data. For example, assume extracted information, from a QR code on an identification card, includes a raw name of “Manning Grover Warren” and assume that there is an input field, of a fillable form, that requires names be entered in “First Name, Last Name” format. If the identification card is determined to be of a first type, then a converted name of “Manning Warren” can be input to the input field. The converted name “Manning Warren” can be generated using a first regular expression for the first type (e.g., one created based on the first type encoding names in “First, Middle, Last” format). On the other hand, if the identification card is determined to be of a second type, then a converted name of “Warren Manning” can be input to the input field. The converted name “Warren Manning” can be generated using a second regular expression for the second type (e.g., one created based on the second type encoding names in a “Last, Middle, First” format).

The above description is provided as an overview of only some implementations of the present disclosure. Further description of those implementations, and other implementations, are described in more detail below.

Some implementations can include a non-transitory computer readable storage medium storing instructions executable by one or more processors (e.g., central processing unit(s) (CPU(s)), graphics processing unit(s) (GPU(s)), and/or tensor processing unit(s) (TPU(s)) to perform a method such as one or more of the methods described above and/or elsewhere herein. Yet other implementations may include a system of one or more computers that include one or more processors operable to execute stored instructions to perform a method such as one or more of the methods described above and/or elsewhere herein.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF THE DRAWINGS

FIG. 1A, FIG. 1B, FIG. 1C, FIG. 1D, and FIG. 1E illustrate views of a user interacting with a form fillable document that can be completed from data automatically parsed and/or formatted according to an identifier associated with the form fillable document and/or a machine-readable identifier.

FIG. 2 illustrates a system for utilizing extracted data from an image of a machine-readable identifier, and application data associated with a document-rendering application, to format the extracted data, and input the formatted extracted data to one or more particular fields of a fillable form document.

FIG. 3 illustrates a method for completing fillable form documents using images of informational documents and conversion data, which can be stored in association with a fillable form document for determining how to supplement and/or format data extracted from the informational documents.

FIG. 4 is a block diagram of an example computer system.

### DETAILED DESCRIPTION

Some implementations set forth herein relate to utilizing extracted data from an image of a machine-readable identifier, and/or application data associated with a document-rendering application, to format the extracted data for one or more particular fields of a fillable form document. For example, a user can access an application, such as a web browser or other application, to view a fillable form document that may be necessary for the user to complete before receiving services from a particular entity (e.g., a medical hospital). The user can be prompted by the application, or a separate application (e.g., an automated assistant), to provide an image of an informational document in order that data can be extracted from the image to assist the user with filling out the fillable form document. For example, an operating system, an automated assistant, and/or any other application can determine, with prior permission from the user, that the user is accessing a particular fillable form document. A determination can be made, based on pre-indexed data and/or data retrieved in response to the user accessing the fillable form document, that a particular classification of informational document may be preferred over other classifications of informational documents to assist with filling out the fillable form document. Alternatively, or additionally, a determination can be made regarding the types of data that may be missing and/formatted incorrectly depending on a classification of informational document that is embodied in an image submitted by the user.

In response to the user accessing the fillable form document, the application and/or separate application can render a GUI prompt for the user to provide an image of an informational document via one or more different modalities. For example, the GUI prompt can include a first selectable element for initializing a camera application to capture an image of an informational document. The GUI prompt can also include a second selectable element for providing a file selection interface through which a user can select an existing image of an informational document and/or machine-readable identifier. When the user selects the first selectable element, the camera application can be initialized and the user can decide to capture an image of their informational document (e.g., an identification card, driver's license, etc.). Alternatively, when the user selects the second selectable element, a file selection interface can be rendered with a set of filtered files that have been filtered from a set of files according to whether the files correspond to images of informational documents. The user can then select an image and/or file to submit to the application and/or separate application for decoding information from a machine-readable identifier that may be included in the image and/or file.

In some implementations, the fillable form document can include one or more input fields, and each input field can be configured to receive data of a respective pre-defined format. For example, the one or more input fields can include a particular input field that has a respective pre-defined format such as, “MM/DD/YY,” in which “MM” refers to a 2-digit month, “DD” refers to a 2-digit day, and “YY” refers to a 2-digit year. Alternatively, or additionally, the one or more input fields can include a separate input field that has a respective pre-defined format such as, “[a-zA-Z]” for a “First Name” field, [\w{1}] for a “Middle Initial” field, and “[a-zA-Z]” for a “Family Name” field. In the aforementioned example, the regular expression “[\w{1}]” can require that the user to limit input for the “Middle Initial” field to a single character, and the regular expression “[a-zA-Z]” can require that the user limit input for the “First Name” field and the “Family Name” field to characters of the alphabet. In some implementations, data characterizing pre-defined formats for fields can be identified in metadata associated with a fillable form document and/or any other data that can be stored in association with the fillable form document.

When the user accesses a fillable form document with one or more different input fields that each require respective pre-defined input formatting, the application and/or separate application can prompt the user to provide inputs for completing the input fields. When a fillable form document is determined to relate to a particular informational document (e.g., a government identification card), the user can be prompted to provide an image of the particular informational document. In some implementations, the application and/or separate application can determine, based on content associated with a fillable form document, the classification of informational document that may be most suitable for retrieving data to incorporate into the input fields. The user can then be prompted to select an image of the particular classification of informational document that has been identified as most suitable for retrieving the data to incorporate into the input fields. In some implementations, a particular classification of informational document can be determined to be most suitable when information extracted from the classification of informational document can complete more input fields of a fillable form document than other classifications of informational documents. Alternatively, or additionally, a particular classification of informational document can be determined to be most suitable when information extracted from the classification of informational document is already formatted for various input fields of a fillable form document—at least compared to other classifications of informational documents.

In some implementations, the application and/or the separate application can determine, based on an image provided by the user, that the informational document characterized by the image may not provide adequate information for the fillable form document. For example, the image can be processed using one or more heuristic processes and/or one or more trained machine learning models to determine a classification of informational document that is included in the image, a type of machine-readable identifier included in the image, information encoded in the image, and/or any other data that can provide an indication of the information included in the image. In some implementations, the classification of an informational document can be identified and compared to the fillable form document and/or data (e.g., metadata) stored in association with the fillable form document. Based on this comparison, the application and/or separate application (e.g., an assistant application) can determine that the informational document may lack certain information for one or more particular input fields of the fillable form document. Alternatively, or additionally, based on this comparison, the application and/or the separate application can determine that the information to be extracted from the informational document may not be formatted correctly for one or more input fields of the fillable form document.

In some implementations, a GUI prompt can be provided to the user in response to the user submitting the image to the application. The GUI prompt can indicate whether any issues have been identified with the image and/or the informational document captured in the image. For example, the GUI prompt can solicit the user to provide a different image of a different informational document, in order that the application can receive information that is detailed enough, and/or formatted properly, for completing the fillable form document. Alternatively, or additionally, the GUI prompt can solicit the user to manually provide any information that may be required to complete the fillable form document, but may not be encoded in the image and/or a machine-readable identifier in the image.

In some implementations, when information extracted from the image and/or the machine-readable identifier is not formatted correctly for a particular input field of the fillable form document, the information can be processed to correct a formatting of the information. For example, a conversion process can be performed to convert a subset of information from a first format to a second format. The subset of information embodying the second format can then be submitted to a particular input field of the fillable form document that requires the second format. For example, information decoded from a machine-readable identifier located in the image of the informational document can include a 9-digit zip code (e.g., “12345-1234”) and a particular input field of the fillable form document can require a 5-digit zip code (e.g., “12345” based on a regular expression “\d{5}$”). Based on these formatting differences, a conversion process can be performed to convert the raw decoded information from a first format (e.g., “12345-1234”) to a second format (e.g., “12345”). The decoded information embodying the second format can then be submitted to a particular input field of the fillable form document.

In some implementations, pre-indexed and/or pre-cached data can be utilized to determine a conversion process to employ for converting decoded information to a particular format and/or identify information that may be missing for certain form fields. For example, conversion data can be stored in association with a particular fillable form document (e.g., a webpage with various input fields), and the conversion data can be provided from a server device to a client device in response to a user accessing the particular fillable form document. An application can then process the conversion data and determine, based on the conversion data, that a particular classification of informational document would be most suitable to provide an image of, in furtherance of completing the fillable form document. Alternatively, or additionally, the client device can provide device data indicating a source of the fillable form document and a classification of informational document that the user is attempting to submit to an application. In response, the server device can generate and/or identify conversion data that indicates how to convert certain information, conveyed by the classification of informational document, into a format(s) that is suitable for one or more respective input fields of the fillable form document. Alternatively, or additionally, in response to the client device providing the device data, the server device can generate and/or identify conversion data that indicates certain information that may be required by the fillable form document but is missing from the information conveyed by the classification of informational document.

In some implementations, when information decoded from an informational document and/or machine-readable identifier does not include certain information that is required by a fillable form document, an automated assistant and/or other application can provide an audible output that solicits a user to provide a spoken input that will provide the application with any missing information. For example, an automated assistant that processes the conversion data can determine that information encrypted and encoded by a machine-readable identifier on an informational document does not include a phone number-which may be required by a particular fillable form document. Based on this determination, the automated assistant can render an audible output such as, “Please speak your phone number for the ‘Phone Number’ input field of this form.” In response, the user can provide a spoken utterance such as, “Ok, 555-1234,” which can be captured as audio data by a client device and processed by the automated assistant. Natural language content derived from the audio data can be parsed to identify content (e.g., the phone number) that is suitable for incorporating into the “Phone Number” input field, and then formatted (e.g., adding a hyphen) to comply with any formatting requirements of the Phone Number input field.

As a result, the user can save time and resources by submitting an image of their informational document without having to manually convert any non-formatted information into a suitable format. Additionally, time and resources can also be preserved when a user is notified of a preferred classification of informational document to submit to complete a particular fillable form document—rather than the user scanning some other informational document that may not result in the auto-filling of as many fields, at least compared to scanning the preferred classification of informational document.

As described herein, a machine-readable identifier can be any visual representation of encoded data and/or encrypted data that can be processed by a computing process to generate a representation of the encoded data. Examples of machine-readable identifiers can include, but are not limited to, QR codes, barcodes, etc. Further, although implementations described herein may be detailed with a QR code as an example of a machine-readable identifier, the implementations described herein may be performed with other types of machine-readable identifiers.

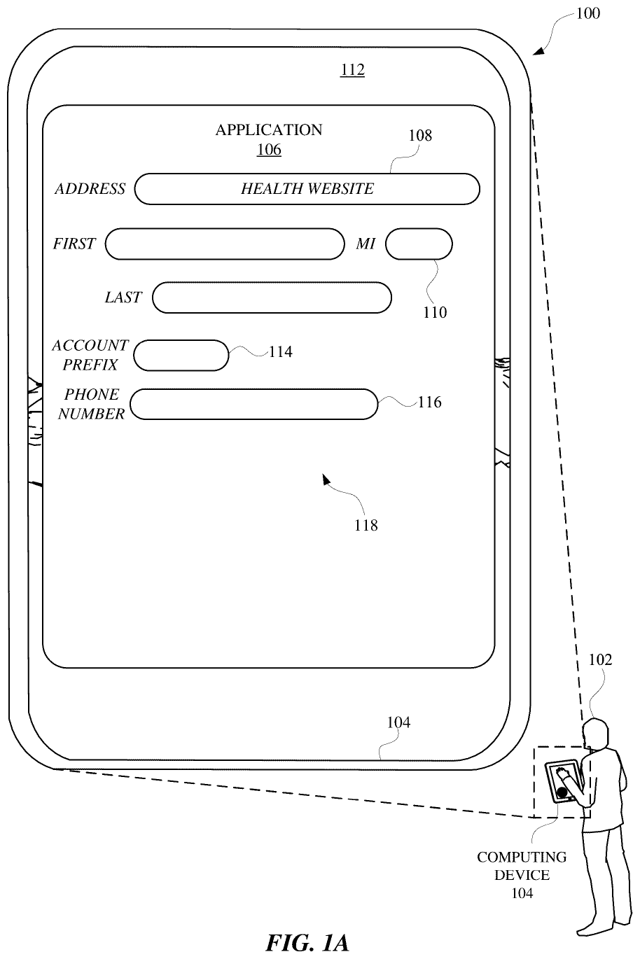

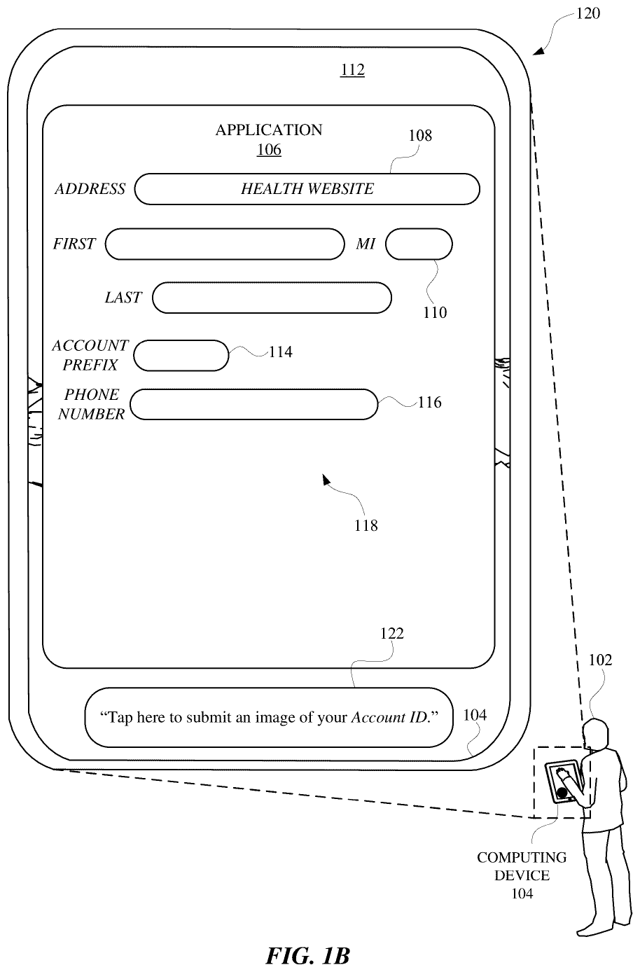

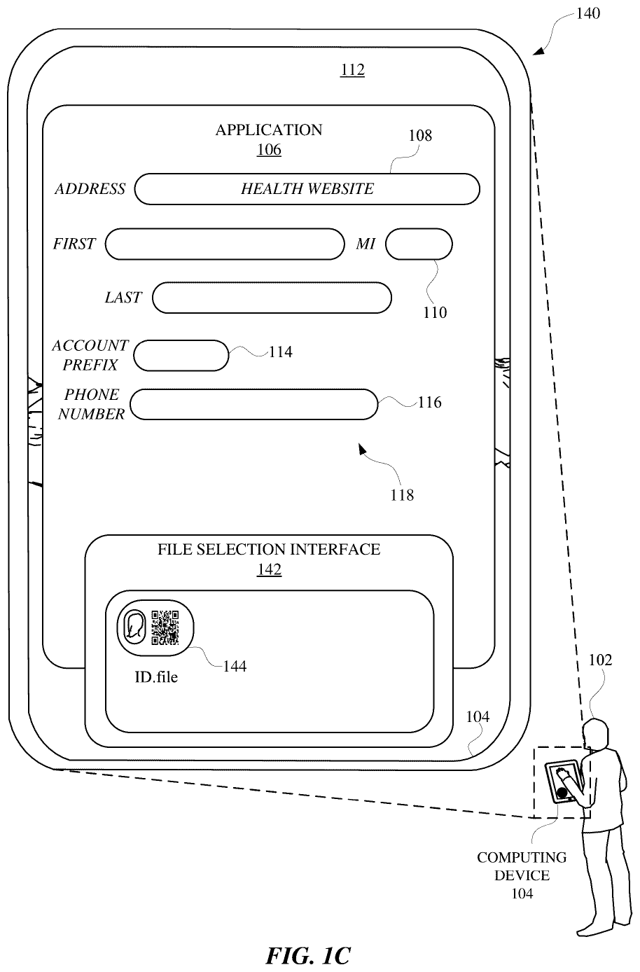

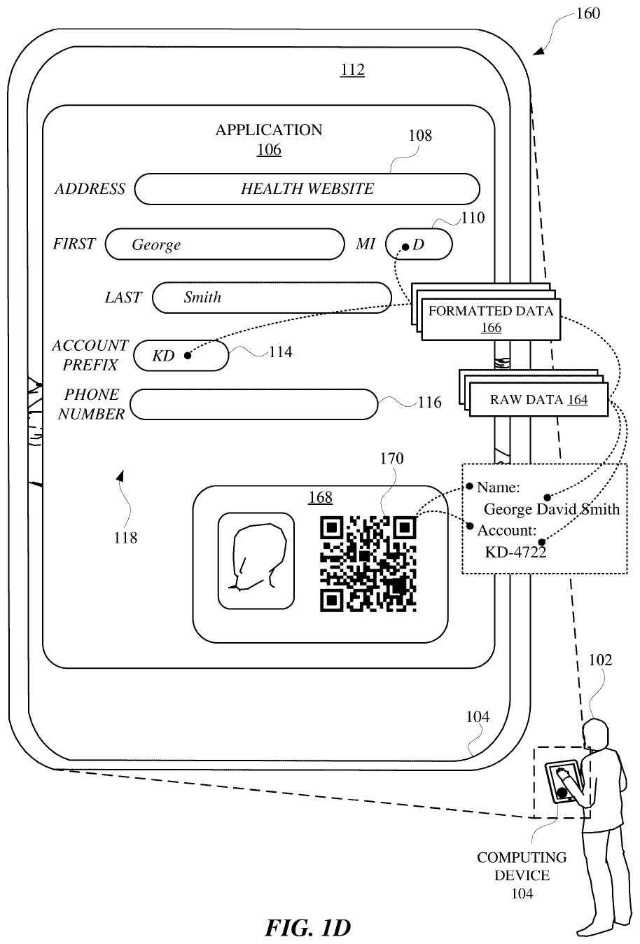

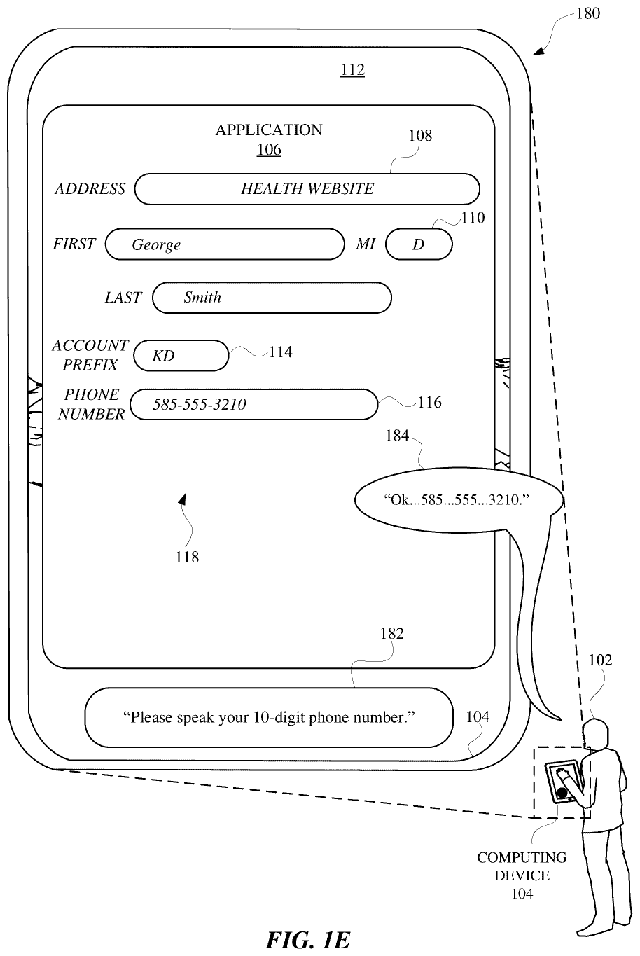

Turning now to the Figures, FIG. 1A, FIG. 1B, FIG. 1C, FIG. 1D, and FIG. 1E illustrate a view 100, view 120, a view 140, a view 160, and a view 180 of a user 102 interacting with a form fillable document that can be completed from data automatically parsed and/or formatted according to an identifier associated with the form fillable document and/or a machine-readable identifier. For example, FIG. 1A illustrates the user 102 interacting with their computing device 104 to cause a display interface 112 of the computing device 104 to access an application 106, such as a web browser and/or another application. The user 102 can navigate to an address 108 (e.g., “Health website” or other URL) to access a particular fillable form document 118 illustrated in view 100 of FIG. 1A. The application 106 and/or a separate application or module (e.g., an automated assistant) can determine, with prior permission from the user 102, that the user 102 is accessing the fillable form document 118. Alternatively, or additionally, the application 106 and/or the separate application can determine an identifier for the application 106, webpage, interface, and/or document being accessed, and determine that the identifier is associated with the fillable form document 118.

The fillable form document 118 can include input fields, such as input fields for a name of the user 102 (e.g., a middle initial input field 110), an account prefix input field 114, a phone number input field 116, and/or any other input field that can be included in a document. In some implementations, an identifier associated with the fillable form document 118 can indicate formatting requirements for one or more input fields for the fillable form document 118 and/or certain informational documents that can be submitted to further completion of the fillable form document 118. For example, pre-cached and/or pre-indexed data can indicate various informational documents that can be utilized to assist with completing the fillable form document 118. Furthermore, for each informational document, one or more conversion expressions can be assigned to assist with converting a format of raw data extracted from a respective informational document. Alternatively, or additionally, for each informational document, one or more portions of information that may be missing from raw data extracted from a respective informational document can be specified.

Based on this identifier for the fillable form document and/or data associated with the identifier, the application 106 and/or a separate application can cause an assistant GUI element 122 to be rendered at the display interface 112, as illustrated in FIG. 1B. The assistant GUI element 122 can include natural language content specifying a particular classification of informational document that may be more suitable than other informational documents for assisting with filling out the fillable form document 118. For example, the application 106 and/or separate application can determine that an “Account ID,” as specified in the assistant GUI element 122, is preferred over other informational documents (e.g., driver's license) because the “Account ID” includes more data for the input fields of the fillable form document than other classifications of informational documents. Therefore, by rendering the assistant GUI element 122, the user 102 can be put on notice that the “Account ID” would be helpful for completing the fillable form document 118.

When the user 102 selects the assistant GUI element 122, the user 102 can be provided with an option to capture an image of an informational document to complete the fillable form document 118, and/or submit an image file corresponding to the informational document. For example, and as illustrated in FIG. 1C, in response to the user 102 selecting the assistant GUI element 122, a file selection interface 142 can be rendered at the display interface 112. In some implementations, a group of files associated with the user 102 can be filtered prior to rendering the file selection interface 142. The group of files can be filtered according to the identifier for the fillable form document 118, and/or one or more features of the fillable form document (e.g., types of input fields, content of the page, etc.). In this way, the user 102 can save time selecting an image of the preferred informational document, rather than navigating through all of the images on their computing device 104 to find the image of the preferred informational document.

When the user 102 selects a file 144 corresponding to an image 168 of an informational document, the image 168 can be processed, as indicated in FIG. 1D. In some implementations, the image 168 can include a machine-readable identifier 170 that can be processed to extract encoded and/or encrypted data. When the encoded data is decoded, raw data 164 can be generated. The raw data 164 can include, for example, a name and an account identifier, which can be accessed by the application 106 and/or separate application with prior permission from the user 102. Additionally, and based on a conversion expression and/or conversion data associated with the identifier and/or informational document captured in the image 168, formatted data 166 can be generated from the raw data 164. The formatted data 166 can be formatted according to data (e.g., metadata) stored in association with the fillable form document 118. For example, a regular expression for an input field 110 can limit the input field 110 to a single alphabet character, therefore the formatted data 166 can convert the name “David” from raw data 164 to a single character “D.” Additionally, a regular expression for the input field 114 can limit the input field 114 to a first two characters (e.g., “KD”) of the account identifier (e.g., “KD-4722”) from the raw data 164, and omit certain other characters such as “special” characters (e.g., “-”) and numbers (e.g., “4722”). The application 106 and/or separate application (e.g., an automated assistant) can then input the formatted data 166 into each respective field.

In some implementations, a determination can be made regarding whether a particular informational document will provide enough data to complete a particular fillable form document 118 that the user 102 is accessing. In some implementations, this information can be pre-indexed and stored in association with an identifier for the fillable form document 118. In this way, in response to determining a classification of an informational document that the user 102 has submitted, the application 106 and/or separate application can identify one or more input fields that the user 102 will have to manually submit information to. For example, in response to the user 102 selecting the file 144, an automated assistant can render a GUI prompt 182 with content such as, “Please speak your 10-digit phone number,” which can solicit the user 102 to provide additional information that may not have been available in the raw data 164 extracted from the machine-readable identifier 170 (e.g., a QR code). Alternatively, or additionally, the content of the GUI prompt 182 can be rendered audibly for the user 102 to respond to. In response, the user 102 can provide a spoken utterance 184 such as, “Ok . . . 585 . . . 555 . . . 3210,” and content of the spoken utterance can be identified, parsed, and formatted according to a formatting requirement of the input field 116. For example, hyphens can be added to the content derived from the spoken utterance 184 based on a regular expression associated with the input field 116 indicating that at least two hyphens are required in the input field 116.

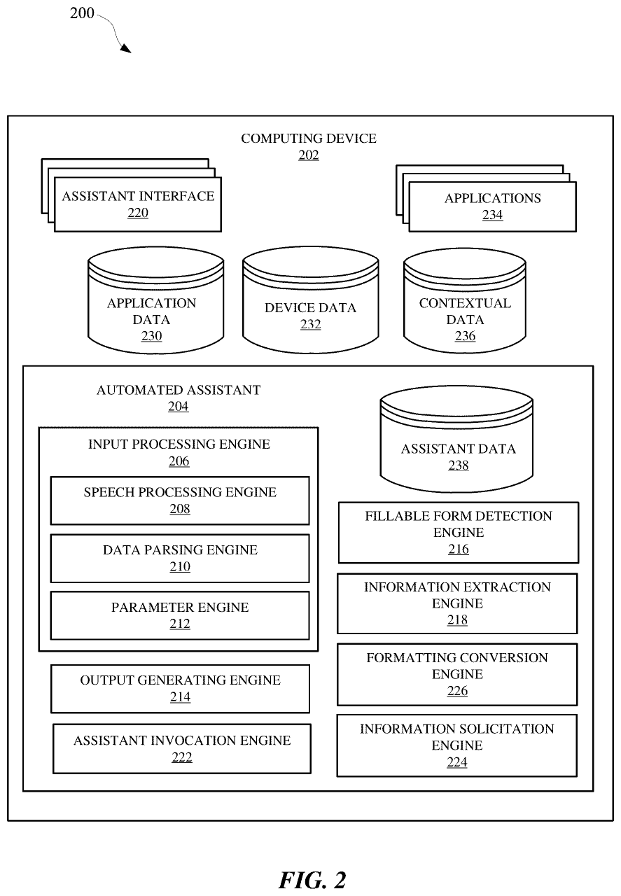

FIG. 2 illustrates a system 200 for utilizing extracted data from an image of a machine-readable identifier, and application data associated with a document-rendering application, to format the extracted data, and input the formatted extracted data to one or more particular fields of a fillable form document. The automated assistant 204 can operate as part of an assistant application that is provided at one or more computing devices, such as a computing device 202 and/or a server device. A user can interact with the automated assistant 204 via assistant interface(s) 220, which can be a microphone, a camera, a touch screen display, a user interface, and/or any other apparatus capable of providing an interface between a user and an application. For instance, a user can initialize the automated assistant 204 by providing a verbal, textual, and/or a graphical input to an assistant interface 220 to cause the automated assistant 204 to initialize one or more actions (e.g., provide data, control a peripheral device, access an agent, generate an input and/or an output, etc.). Alternatively, the automated assistant 204 can be initialized based on processing of contextual data 236 using one or more trained machine learning models. The contextual data 236 can characterize one or more features of an environment in which the automated assistant 204 is accessible, and/or one or more features of a user that is predicted to be intending to interact with the automated assistant 204. The computing device 202 can include a display device, which can be a display panel that includes a touch interface for receiving touch inputs and/or gestures for allowing a user to control applications 234 of the computing device 202 via the touch interface. In some implementations, the computing device 202 can lack a display device, thereby providing an audible user interface output, without providing a graphical user interface output. Furthermore, the computing device 202 can provide a user interface, such as a microphone, for receiving spoken natural language inputs from a user. In some implementations, the computing device 202 can include a touch interface and can be void of a camera, but can optionally include one or more other sensors.

The computing device 202 and/or other third party client devices can be in communication with a server device over a network, such as the internet. Additionally, the computing device 202 and any other computing devices can be in communication with each other over a local area network (LAN), such as a Wi-Fi network, and/or a wide area network (WAN) such as a cellular network. The computing device 202 can offload computational tasks to the server device in order to conserve computational resources at the computing device 202. For instance, the server device can host the automated assistant 204, and/or computing device 202 can transmit inputs received at one or more assistant interfaces 220 to the server device. However, in some implementations, the automated assistant 204 can be hosted at the computing device 202, and various processes that can be associated with automated assistant operations can be performed at the computing device 202.

In various implementations, all or less than all aspects of the automated assistant 204 can be implemented on the computing device 202. In some of those implementations, aspects of the automated assistant 204 are implemented via the computing device 202 and can interface with a server device, which can implement other aspects of the automated assistant 204. The server device can optionally serve a plurality of users and their associated assistant applications via multiple threads. In implementations where all or less than all aspects of the automated assistant 204 are implemented via computing device 202, the automated assistant 204 can be an application that is separate from an operating system of the computing device 202 (e.g., installed “on top” of the operating system)—or can alternatively be implemented directly by the operating system of the computing device 202 (e.g., considered an application of, but integral with, the operating system).

In some implementations, the automated assistant 204 can include an input processing engine 206, which can employ multiple different modules for processing inputs and/or outputs for the computing device 202 and/or a server device. For instance, the input processing engine 206 can include a speech processing engine 208, which can process audio data received at an assistant interface 220 to identify the text embodied in the audio data. The audio data can be transmitted from, for example, the computing device 202 to the server device in order to preserve computational resources at the computing device 202. Additionally, or alternatively, the audio data can be exclusively processed at the computing device 202.

The process for converting the audio data to text can include a speech recognition algorithm, which can employ neural networks, and/or statistical models for identifying groups of audio data corresponding to words or phrases. The text converted from the audio data can be parsed by a data parsing engine 210 and made available to the automated assistant 204 as textual data that can be used to generate and/or identify command phrase(s), intent(s), action(s), slot value(s), and/or any other content specified by the user. In some implementations, output data provided by the data parsing engine 210 can be provided to a parameter engine 212 to determine whether the user provided an input that corresponds to a particular intent, action, and/or routine capable of being performed by the automated assistant 204 and/or an application or agent that is capable of being accessed via the automated assistant 204. For example, assistant data 238 can be stored at the server device and/or the computing device 202, and can include data that defines one or more actions capable of being performed by the automated assistant 204, as well as parameters necessary to perform the actions. The parameter engine 212 can generate one or more parameters for an intent, action, and/or slot value, and provide the one or more parameters to an output generating engine 214. The output generating engine 214 can use the one or more parameters to communicate with an assistant interface 220 for providing an output to a user, and/or communicate with one or more applications 234 for providing an output to one or more applications 234.

In some implementations, the automated assistant 204 can be an application that can be installed “on-top of” an operating system of the computing device 202 and/or can itself form part of (or the entirety of) the operating system of the computing device 202. The automated assistant application includes, and/or has access to, on-device speech recognition, on-device natural language understanding, and on-device fulfillment. For example, on-device speech recognition can be performed using an on-device speech recognition module that processes audio data (detected by the microphone(s)) using an end-to-end speech recognition machine learning model stored locally at the computing device 202. The on-device speech recognition generates recognized text for a spoken utterance (if any) present in the audio data. Also, for example, on-device natural language understanding (NLU) can be performed using an on-device NLU module that processes recognized text, generated using the on-device speech recognition, and optionally contextual data, to generate NLU data.

NLU data can include intent(s) that correspond to the spoken utterance and optionally parameter(s) (e.g., slot values) for the intent(s). On-device fulfillment can be performed using an on-device fulfillment module that utilizes the NLU data (from the on-device NLU), and optionally other local data, to determine action(s) to take to resolve the intent(s) of the spoken utterance (and optionally the parameter(s) for the intent). This can include determining local and/or remote responses (e.g., answers) to the spoken utterance, interaction(s) with locally installed application(s) to perform based on the spoken utterance, command(s) to transmit to internet-of-things (IOT) device(s) (directly or via corresponding remote system(s)) based on the spoken utterance, and/or other resolution action(s) to perform based on the spoken utterance. The on-device fulfillment can then initiate local and/or remote performance/execution of the determined action(s) to resolve the spoken utterance.

In various implementations, remote speech processing, remote NLU, and/or remote fulfillment can at least selectively be utilized. For example, recognized text can at least selectively be transmitted to remote automated assistant component(s) for remote NLU and/or remote fulfillment. For instance, the recognized text can optionally be transmitted for remote performance in parallel with on-device performance, or responsive to failure of on-device NLU and/or on-device fulfillment. However, on-device speech processing, on-device NLU, on-device fulfillment, and/or on-device execution can be prioritized at least due to the latency reductions they provide when resolving a spoken utterance (due to no client-server roundtrip(s) being needed to resolve the spoken utterance). Further, on-device functionality can be the only functionality that is available in situations with no or limited network connectivity.

In some implementations, the computing device 202 can include one or more applications 234 which can be provided by a third-party entity that is different from an entity that provided the computing device 202 and/or the automated assistant 204. An application state engine of the automated assistant 204 and/or the computing device 202 can access application data 230 to determine one or more actions capable of being performed by one or more applications 234, as well as a state of each application of the one or more applications 234 and/or a state of a respective device that is associated with the computing device 202. A device state engine of the automated assistant 204 and/or the computing device 202 can access device data 232 to determine one or more actions capable of being performed by the computing device 202 and/or one or more devices that are associated with the computing device 202. Furthermore, the application data 230 and/or any other data (e.g., device data 232) can be accessed by the automated assistant 204 to generate contextual data 236, which can characterize a context in which a particular application 234 and/or device is executing, and/or a context in which a particular user is accessing the computing device 202, accessing an application 234, and/or any other device or module.

While one or more applications 234 are executing at the computing device 202, the device data 232 can characterize a current operating state of each application 234 executing at the computing device 202. Furthermore, the application data 230 can characterize one or more features of an executing application 234, such as content of one or more graphical user interfaces being rendered at the direction of one or more applications 234. Alternatively, or additionally, the application data 230 can characterize an action schema, which can be updated by a respective application and/or by the automated assistant 204, based on a current operating status of the respective application. Alternatively, or additionally, one or more action schemas for one or more applications 234 can remain static, but can be accessed by the application state engine in order to determine a suitable action to initialize via the automated assistant 204.

The computing device 202 can further include an assistant invocation engine 222 that can use one or more trained machine learning models to process application data 230, device data 232, contextual data 236, and/or any other data that is accessible to the computing device 202. The assistant invocation engine 222 can process this data in order to determine whether or not to wait for a user to explicitly speak an invocation phrase to invoke the automated assistant 204, or consider the data to be indicative of an intent by the user to invoke the automated assistant—in lieu of requiring the user to explicitly speak the invocation phrase. For example, the one or more trained machine learning models can be trained using instances of training data that are based on scenarios in which the user is in an environment where multiple devices and/or applications are exhibiting various operating states. The instances of training data can be generated in order to capture training data that characterizes contexts in which the user invokes the automated assistant and other contexts in which the user does not invoke the automated assistant. When the one or more trained machine learning models are trained according to these instances of training data, the assistant invocation engine 222 can cause the automated assistant 204 to detect, or limit detecting, spoken invocation phrases from a user based on features of a context and/or an environment.

In some implementations, the system 200 can include a fillable form detection engine 216 that can determine, with prior permission from a user, whether the user is accessing a fillable form document via the computing device 202 or another computing device. In some implementations, the fillable form detection engine 216 can make this determination based on the application data 230, device data 232, contextual data 236 and/or any other data that can be associated with a fillable form document. For example, the application data 230 can include a website URL for a website that the user is accessing. The fillable form detection engine 216 can process this website URL to determine whether the website URL is associated with a particular fillable form document. When the website URL is determined to be associated with a particular fillable form document, the fillable form detection engine 216 can identify conversion data that can indicate one or more different classifications of informational documents that can be utilized to complete the fillable form document. In some implementations, the conversion data can also indicate, for each particular classification of informational documents, certain portions of information that should be reformatted for entry into the particular fillable form document and/or one or more other fillable form documents. Alternatively, or additionally, the conversion data can also indicate, for each particular classification of informational documents, certain information that the user may have to submit manually to the fillable form document because a respective classification of informational document may not provide the certain information.

In some implementations, the system can include an information extraction engine 218, which can determine a process and/or operation for decoding and/or decrypting information embodied in a machine-readable identifier of an informational document (e.g., a passport, driver's license, etc.). In some implementations, a determination of a particular process to perform for decoding and/or decrypting information can be selected based on a classification of the informational document and/or an identifier associated with the fillable form document. For example, a QR code provided on a first classification of informational document can be decoded differently from another QR code provided on a second classification of informational document.

In some implementations, the system 200 can include a formatting conversion engine 226 that can process the conversion data identified by the fillable form detection engine 216, and determine how to re-format certain portions of information extracted from a machine-readable identifier and/or an informational document. For example, the conversion data can indicate that a birth date provided on a passport classification of document should be reformatted (e.g., to be shortened from 8-digits to 6-digits) according to a regular expression for a birthday input field of a fillable form document that a user is accessing. When the formatting conversion engine 226 has formatted the raw data extracted from the fillable form document accordingly, an information solicitation engine 224 can determine whether any input fields require extra data not provided by the informational document. In other words, the information solicitation engine 224 can determine that a particular input field has not been automatically filled and, in response, generate a prompt for soliciting the user to manually provide the information necessary to complete the particular input field. The prompt can be, for example, a GUI prompt and/or audible output that solicits the user to manually type input(s) into the remaining empty input fields and/or provide a spoken utterance that embodies the content to be incorporated into the remaining empty input fields.

FIG. 3 illustrates a method 300 for completing fillable form documents using images of informational documents and conversion data, which can be stored in association with a fillable form document for determining how to supplement and/or format data extracted from the informational documents. The method 300 can be performed by one or more computing devices, applications, and/or any other apparatus or module that can be associated with a fillable form document. The method 300 can include an operation 302 of determining whether a fillable form document is being accessed by a user. In some implementations, the user can access a fillable form document via a web browser and/or other application. A determination regarding whether the user is accessing the fillable form document can be performed, with prior permission from the user, by the application and/or a separate application or module of an operating system. For example, an automated assistant can determine, with prior permission from the user, that a display interface of a computing device is rendering a fillable form document for the user. When the user is determined to be accessing a fillable form document, the method 300 can proceed from the operation 302 to an operation 304. Otherwise, the method 300 may not proceed until the user is accessing a fillable form document.

The operation 304 can include determining an identifier associated with the fillable form document. The identifier can be utilized to correlate the fillable form document to data that can be utilized to assist with completing one or more input fields of the fillable form document. In some implementations, identifiers for various fillable form documents can be pre-indexed (e.g., by a web crawler or other application) to correlate the respective sources of the various fillable form documents (e.g., a website URL, application name, service provider, etc.) with features of the corresponding fillable form documents. Alternatively, or additionally, identifiers (e.g., a web URL, token, and/or other identifier) for the various fillable form documents can be pre-indexed to correlate the fillable form documents with certain classifications of informational documents, as well as instructions for processing each classification of informational document. The method 300 can proceed from the operation 304 to an operation 306, which can include determining whether the identifier associated with the fillable form document is also associated with data that identifies one or more particular informational documents.

For example, a fillable form document can be provided by a hospital website as a way to register new patients. An identifier (e.g., an address for the hospital) associated with the fillable form document can correlate the hospital website with information regarding certain classifications of informational documents that can be utilized when completing the fillable form document. Alternatively, or additionally, the identifier associated with the fillable form document can correlate the hospital website and/or each classification of informational document with formatting requirements for respective input fields of the fillable form document. In some implementations, data stored in association with the identifier can indicate conversion expressions and/or conversion data that can be utilized to convert extracted raw data from respective informational documents into other respective format(s) suitable for completing certain input fields of one or more input fields of the fillable form document.

For example, the identifier can be associated with conversion data (e.g., pre-indexed data) that indicates a portion of extracted information (e.g., a hire date) from a first classification of informational document (e.g., an encrypted QR code on an employee badge) should be converted according to a first regular expression for a particular field of a particular fillable form document. Additionally, the conversion data can also indicate that a different portion of extracted information (e.g., an expiration date) from a second classification of informational document (e.g., a QR code on a driver's license) should be converted according to a second regular expression for the particular field of the particular fillable form document.

When the identifier is determined to be associated with one or more particular informational documents, the method 300 can proceed from the operation 306 to an operation 310. Otherwise, the method 300 can proceed from the operation 306 to an operation 308, which can include soliciting the user for manual entries to complete the fillable form document. The operation 310 can include soliciting the user for an image of a particular classification of informational document. In some implementations, the application can solicit the user for an image of a preferred classification of informational document that is most conducive to completing the fillable form document with minimal manual entries from the user. For example, when the identifier corresponds to the hospital website, the particular classification of informational document preferred for the hospital website can be a first classification of informational document (e.g., an insurance card). This determination can be based on the first classification of informational document providing all but X number of entries for input fields of the fillable form document, and other classifications of informational documents (e.g., a driver's license, library card, etc.) providing all but Y number of entries, where Y>X.

The user can be solicited to provide the image of the particular classification of informational document through one or more interfaces of a computing device. For example, a display interface and/or an audio interface of the computing device can render a prompt for the user to submit an image of a particular classification of informational document to complete the fillable form document. In some implementations, the prompt can be a GUI prompt that includes a first selectable element for initializing a camera application to capture an image of an informational document, and a second selectable element for initializing a file selection interface for selecting an image to be processed by an application in furtherance of completing the fillable form document. Alternatively, or additionally, the prompt can be a GUI prompt that includes a third selectable element for allowing the user to elect to manually enter information into the fillable form document.

In some implementations, in response to selecting the second selectable element, the file selection interface can be rendered with a list of files. The list of files can be a filtered set of files that have been filtered from a group of files according to whether each respective file of the group of files includes an image of a document that can be utilized to complete the fillable form document. In some implementations, a process for filtering the group of files can be performed based on the identifier associated with the fillable form document. In this way, images that include the preferred classification of informational document can remain in the filtered set of files for the user to select for submitting to the application, while other images that do not include the preferred classification of informational document can be filtered out.

When the user submits the image of an informational document, either by selecting a file and/or capturing an image with their camera, the method 300 can proceed from the operation 310 to an operation 312. The operation 312 can include extracting data from an image of an informational document according to conversion data associated with the particular classification of informational document and/or another classification of informational document. For example, the user may submit an image of the particular classification of informational document, which is determined to be preferred for the fillable form document, or submit an image of a different classification of informational document. One or more image processing techniques can be utilized to identify the classification of informational document that has been submitted by the user and, based on this classification of informational document, extract information for the fillable form document.

In some implementations, the extracted information can extracted be according to conversion data that is identified using the identifier for the fillable form document. For example, conversion data associated with the identifier can indicate that for a first classification of informational document (e.g., an employee badge), a QR code should be processed according to a first process and/or that a birthdate extracted from the QR code should undergo a formatting conversion. The birthdate extracted as raw data can be in “MM/DD/YYYY” format, and the conversion data can indicate that the year portion of the raw data (e.g., “YYYY”) should be converted, according to a selected regular expression, to a 2-digit format (e.g., “YY”). Alternatively, or additionally, the conversion data associated with the identifier can also indicate that for a second classification of informational document (e.g., a driver's license), a different QR code on the informational document should be processed according to a second process, and/or that a birthdate extracted from the QR code should undergo a different formatting conversion. For this separate formatting conversion, the birthdate extracted as raw data can be in a “DD/MM/YY” format, and the conversion data can indicate that the “MM” and “DD” portions of the raw data should be formatted to swap their positions (e.g., to be “MM/DD/YY”). In some implementations, different conversion data can be associated with different identifiers, such that formatting, input solicitation, and/or other processes can be performed differently according to the different identifiers, and thus different sources for fillable form documents.

The method 300 can proceed from the operation 312 to an operation 314, which can include converting formatting of the extracted information according to pre-indexed data and/or the submitted informational document. Formatting of extracted information can be modified depending on a particular classification of informational document that is submitted, and/or an identifier for the fillable form document. In other words, when the user submits an image that may not correspond to a preferred and/or expected classification of informational document, the image can nonetheless be processed to identify a classification of informational document that was submitted. The identified classification can then be compared to the pre-indexed data and/or other data for determining the portions of the raw data that should undergo respective formatting conversions and/or for determining what information to solicit from the user as manual inputs (e.g., spoken utterance, typed input, etc.).

The method 300 can proceed from the operation 314 to an operation 316 of determining whether the submitted informational document is missing information for completing one or more input fields of the fillable form document. When certain information is determined unavailable via the submitted informational document for completing the fillable form document, the method 300 can proceed to the operation 308, and then to an operation 318. Otherwise, when there is no information determined to be missing for completing the fillable form document, the method 300 can proceed to the operation 318. The operation 318 can include submitting any received information to the input field(s) of the fillable form document. In other words, information that has been formatted for the fillable form document can be submitted to each respective field that the formatted information is intended for. Additionally, information received manually as a result of certain information being missing from the informational document can be submitted to their intended fields of the fillable form document. Optionally, an operation of submitting the fillable form can occur following the operation 318. For example, the fillable form can be automatically submitted once all required information is input into the fields and without any further prompting to the user. Also, for example, the fillable form can be automatically submitted once all required information is input into the fields and after a user has provided affirmative input in response to a prompt for the user to verify the accuracy of the information input into the fields. For example, it can be automatically submitted responsive to the user speaking “yes” in response to an audible prompt of “Say yes if everything looks good and you are ready to submit”. Automatically submitting the form can include, for example, emulating an actuation of a submit interface element that is being rendered or executing a post( ) function of the document rendering the fillable form.

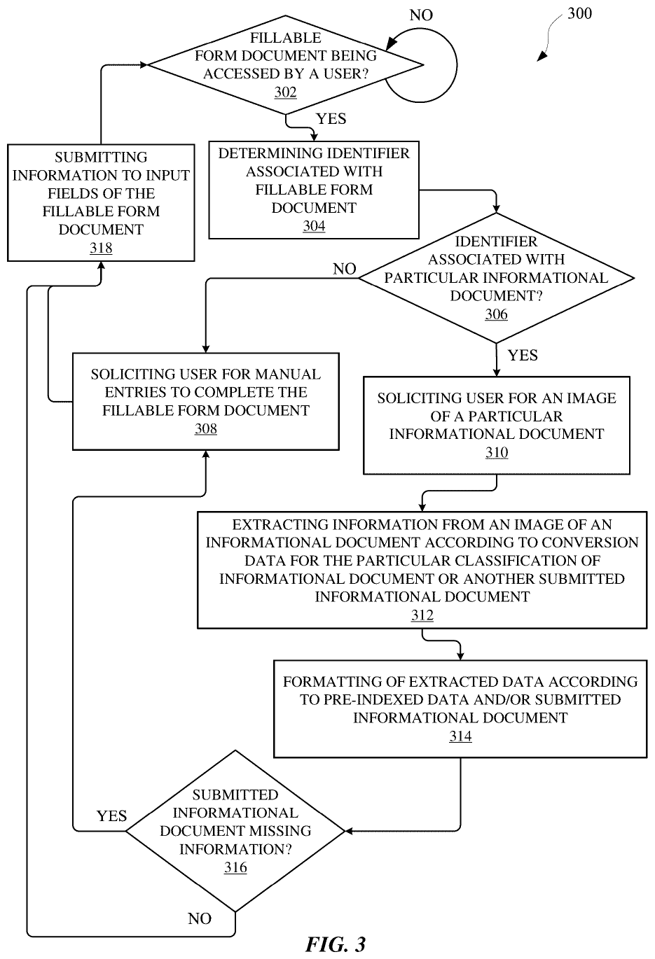

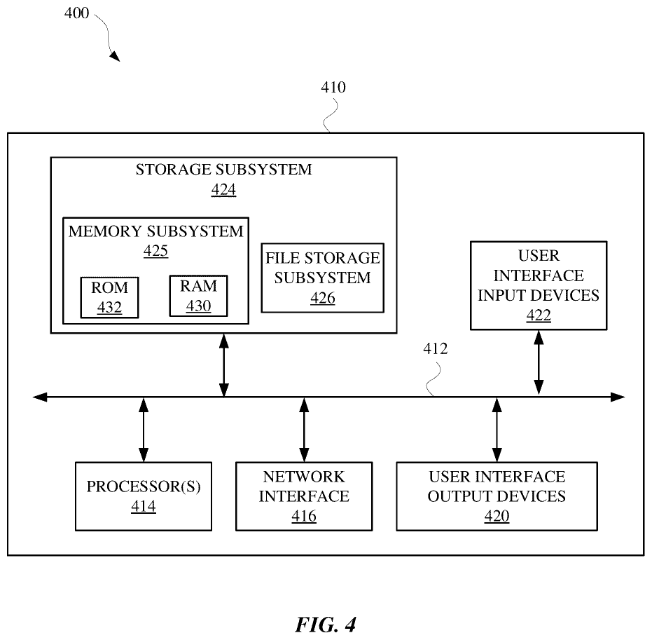

FIG. 4 is a block diagram 400 of an example computer system 410. Computer system 410 typically includes at least one processor 414 which communicates with a number of peripheral devices via bus subsystem 412. These peripheral devices may include a storage subsystem 424, including, for example, a memory 425 and a file storage subsystem 426, user interface output devices 420, user interface input devices 422, and a network interface subsystem 416. The input and output devices allow user interaction with computer system 410. Network interface subsystem 416 provides an interface to outside networks and is coupled to corresponding interface devices in other computer systems.

User interface input devices 422 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into computer system 410 or onto a communication network.

User interface output devices 420 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computer system 410 to the user or to another machine or computer system.

Storage subsystem 424 stores programming and data constructs that provide the functionality of some or all of the modules described herein. For example, the storage subsystem 424 may include the logic to perform selected aspects of method 300, and/or to implement one or more of system 200, computing device 104, automated assistant, and/or any other application, device, apparatus, and/or module discussed herein.

These software modules are generally executed by processor 414 alone or in combination with other processors. Memory 425 used in the storage subsystem 424 can include a number of memories including a main random-access memory (RAM) 430 for storage of instructions and data during program execution and a read only memory (ROM) 432 in which fixed instructions are stored. A file storage subsystem 426 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 426 in the storage subsystem 424, or in other machines accessible by the processor(s) 414.

Bus subsystem 412 provides a mechanism for letting the various components and subsystems of computer system 410 communicate with each other as intended. Although bus subsystem 412 is shown schematically as a single bus, alternative implementations of the bus subsystem may use multiple busses.

Computer system 410 can be of varying types including a workstation, server, computing cluster, blade server, server farm, or any other data processing system or computing device. Due to the ever-changing nature of computers and networks, the description of computer system 410 depicted in FIG. 4 is intended only as a specific example for purposes of illustrating some implementations. Many other configurations of computer system 410 are possible having more or fewer components than the computer system depicted in FIG. 4.

In situations in which the systems described herein collect personal information about users (or as often referred to herein, “participants”), or may make use of personal information, the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

In some implementations, a method implemented by one or more processors is provided and includes determining that a user is accessing a fillable form document that is being rendered by an application of a computing device. The fillable form document includes one or more input fields that are each configured to receive user input of a respective predefined format. The method can further include processing image data to extract information that is encoded by a machine-readable identifier. The image data characterizes an image that: includes the machine-readable identifier, and is captured by a camera of the computing device or another computing device. The method can further include determining, based on processing the image data, that a portion of the information encoded by the machine-readable identifier, when decoded, is not formatted according to a particular predefined format for a particular input field of the one or more input fields. The method can further include processing, based on determining that the portion of the information is not formatted according to the particular predefined format, the portion of the information to convert the portion of the information into the particular predefined format. The method can further include causing, based on processing the portion of the information, the computing device to submit input data to the particular input field of the application. The input data characterizes the portion of the information in the particular predefined format.

These and other implementations of the technology disclosed herein can optionally include one or more of the following features.

In some implementations, processing the portion of the information to convert the portion of the information into the particular predefined format includes selecting, by the computing device, one or more regular expressions for formatting the information encoded by the machine-readable identifier. The formatted input data is generated based on processing the information using the one or more regular expressions. In some of those implementations, selecting the one or more regular expressions for formatting the information encoded by the machine-readable identifier includes selecting a certain regular expression when a format of information encoded by the machine-readable identifier corresponds to a certain format, and selecting a different regular expression when the format of the information encoded by the machine-readable identifier corresponds to a different format.

In some implementations, processing image data to extract the information that is encoded by the machine-readable identifier includes determining a classification for an informational document that is included in the image with the machine-readable identifier. In some of those implementations, the machine-readable identifier is included on a surface of the informational document, and a process for extracting the information is selected based on the classification for the informational document.

In some implementations, the method can further include, in response to determining that the user is accessing the fillable form document, causing, by the computing device, a graphical user interface (GUI) prompt to be rendered for directing the user to capture an image of the machine-readable identifier. In some of those implementations, the image of the machine-readable identifier is captured responsive to the GUI prompt being rendered.

In some implementations, the method can further include, in response to determining that the user is accessing the fillable form document, causing, by the computing device, a graphical user interface (GUI) prompt to be rendered for directing the user to provide an image of an informational documents, and the image of the machine-readable identifier is provided responsive to the GUI prompt being rendered. In some versions of those implementations, the GUI prompt includes a first selectable element for rendering a camera interface, and a second selectable element for rendering a file selection interface. In some of those versions, the method can further include determining, by the computing device, that the user selected the second selectable element at the GUI prompt, and causing, in response to determining that the user selected the second selectable element, the file selection interface to be rendered with one or more selectable icons corresponding to a set of filtered files. In those versions, the set of filtered files are filtered, from a set of files, based on each file of the set of filtered files being classified as an informational document image, and the image is selected from the set of filtered files.

In some implementations, a method implemented by one or more processors is provided and includes determining that a user is accessing a type of fillable form document that is being rendered by an application of the computing device or a separate computing device. The type of fillable form document includes one or more input fields that receive user input. The method can further include processing image data to extract information that is encoded by a machine-readable identifier. The image data characterizes an image that: includes the machine-readable identifier, and is captured by a camera of the computing device or another computing device. The method can further include determining that the information encoded by the machine-readable identifier, when decoded, is missing certain information for a particular field of the one or more input fields. The method can further include causing, based on determining that the information encoded by the machine-readable identifier is missing the certain information, a prompt to be rendered for directing the user to provide the certain information for completing the particular field of the one or more input fields.

These and other implementations of the technology disclosed herein can optionally include one or more of the following features.

In some implementations, processing image data to extract the information that is encoded by a machine-readable identifier includes determining a particular classification of documents for an informational document that is included in the image with the machine-readable identifier, where the machine-readable identifier is included on a surface of the informational document.

In some implementations, determining that the information encoded by the machine-readable identifier, when decoded, is missing certain information for the particular field of the one or more input fields includes determining that the certain information is not included with the particular classification of documents. In some of those implementations, the prompt is a graphical user interface (GUI) prompt that includes natural language content that is associated with the certain information not included with the particular classification of documents.

In some implementations, causing the prompt to be rendered for directing the user to provide the certain information for completing the particular field of the one or more input fields includes causing the GUI prompt to be rendered with other content that identifies a separate classification of documents. The separate classification of documents includes the certain information not included with the particular classification of documents.

In some implementations, causing the prompt to be rendered for directing the user to provide the certain information for completing the particular field of the one or more input fields includes causing the prompt to be rendered as an audible output that solicits the user to provide the certain information via a spoken utterance to an audio interface of the computing device or the separate computing device.

In some implementations, the method can further include receiving, from the user and in response to causing the prompt to be rendered, a particular spoken utterance that embodies additional information for completing the particular field of the one or more input fields, and causing, in response to receiving the spoken utterance, the additional information to be incorporated into the particular field of the one or more input fields according to a predefined format of the particular field.

In some implementations, a method implemented by one or more processors is provided and includes determining an identifier for a website that a user is accessing via a display interface of a computing device. The website includes a fillable form document that includes one or more input fields that are each configured to receive user input of a respective predefined format. The method can further include causing, based on the identifier for the website, an interface of the computing device or a separate computing device to render a prompt for directing the user to provide an image of a particular classification of informational document. The method can further include processing image data to extract information that is provided by the particular classification of informational document, where the image data characterizes a particular image that is captured by a camera of the computing device or another computing device. The method can further include processing, based on the identifier for the website, at least a portion of the extracted information to convert at least the portion of the extracted information into a particular predefined format for a particular input field of the one or more input fields. The method can further include causing, based on processing at least the portion of the extracted information, input data to be submitted to the particular input field of the fillable form document, where the input data characterizes the portion of the information in the particular predefined format.

These and other implementations of the technology disclosed herein can optionally include one or more of the following features.

In some implementations, the method can further include determining, based on processing the image data, that the user provided a particular image of a different classification of informational document, and causing, based on processing the image data, a prompt to be rendered for directing the user to provide an additional image of the particular classification of informational document, where the extracted information is from the additional image submitted by the user.

In some implementations, processing at least the portion of the extracted information to convert at least the portion of the extracted information into the particular predefined format includes determining that the particular image includes a particular type of machine-readable identifier, where at least the portion of the extracted information is converted into the particular predefined format based on the particular type of machine-readable identifier.

In some implementations, the identifier for the website is a uniform resource locator (URL) or other uniform resource identifier (URI).

In some implementations, the method can further include causing, based at least on the identifier for the website, the interface of the computing device or the separate computing device to render an additional prompt for directing the user to provide a textual input for completing at least one input field of the one or more input fields.

In some implementations, the method can further include causing, based at least on the identifier for the website, the computing device or the separate computing device to render an audible prompt that directs the user to provide a spoken input for completing at least one input field of the one or more input fields.

1. A method implemented by one or more processors, the method comprising:
determining that a user is accessing a fillable form document that is being rendered by an application of a computing device,
wherein the fillable form document includes one or more input fields that are each configured to receive user input of a respective predefined format;
processing image data to extract information that is encoded by a machine-readable identifier,
wherein the image data characterizes an image that: includes the machine-readable identifier, and is captured by a camera of the computing device or another computing device;
determining, based on processing the image data, that a portion of the information encoded by the machine-readable identifier, when decoded, is not formatted according to a particular predefined format for a particular input field of the one or more input fields;
processing, based on determining that the portion of the information is not formatted according to the particular predefined format, the portion of the information to convert the portion of the information into the particular predefined format; and
causing, based on processing the portion of the information, the computing device to submit input data to the particular input field of the application,
wherein the input data characterizes the portion of the information in the particular predefined format.

2. The method of claim 1, wherein processing the portion of the information to convert the portion of the information into the particular predefined format includes:
selecting, by the computing device, one or more regular expressions for formatting the information encoded by the machine-readable identifier,
wherein the formatted input data is generated based on processing the information using the one or more regular expressions.

3. The method of claim 2, wherein selecting the one or more regular expressions for formatting the information encoded by the machine-readable identifier includes:
selecting a certain regular expression when a format of information encoded by the machine-readable identifier corresponds to a certain format, and
selecting a different regular expression when the format of the information encoded by the machine-readable identifier corresponds to a different format.

4. The method of claim 2, wherein processing image data to extract the information that is encoded by the machine-readable identifier includes:
determining a classification for an informational document that is included in the image with the machine-readable identifier,
wherein the machine-readable identifier is included on a surface of the informational document, and
wherein a process for extracting the information is selected based on the classification for the informational document.

5. The method of claim 1, further comprising: in response to determining that the user is accessing the fillable form document:
causing, by the computing device, a graphical user interface (GUI) prompt to be rendered for directing the user to capture an image of the machine-readable identifier,
wherein the image of the machine-readable identifier is captured responsive to the GUI prompt being rendered.

6. The method of claim 1, further comprising:
in response to determining that the user is accessing the fillable form document:
causing, by the computing device, a graphical user interface (GUI) prompt to be rendered for directing the user to provide an image of an informational document,
wherein the image of the machine-readable identifier is provided responsive to the GUI prompt being rendered.

7. The method of claim 6, wherein the GUI prompt includes a first selectable element for rendering a camera interface, and a second selectable element for rendering a file selection interface.

8. The method of claim 7, further comprising:
determining, by the computing device, that the user selected the second selectable element at the GUI prompt; and
causing, in response to determining that the user selected the second selectable element, the file selection interface to be rendered with one or more selectable icons corresponding to a set of filtered files,
wherein the set of filtered files are filtered, from a set of files, based on each file of the set of filtered files being classified as an informational document image, and
wherein the image is selected from the set of filtered files.

9. A method implemented by one or more processors, the method comprising:
determining that a user is accessing a type of fillable form document that is being rendered by an application of the computing device or a separate computing device,
wherein the type of fillable form document includes one or more input fields that receive user input;
processing image data to extract information that is encoded by a machine-readable identifier,
wherein the image data characterizes an image that: includes the machine-readable identifier, and is captured by a camera of the computing device or another computing device;
determining that the information encoded by the machine-readable identifier, when decoded, is missing certain information for a particular field of the one or more input fields; and
causing, based on determining that the information encoded by the machine-readable identifier is missing the certain information, a prompt to be rendered for directing the user to provide the certain information for completing the particular field of the one or more input fields.

10. The method of claim 9, wherein processing image data to extract the information that is encoded by a machine-readable identifier includes:
determining a particular classification of documents for an informational document that is included in the image with the machine-readable identifier,
wherein the machine-readable identifier is included on a surface of the informational document.

11. The method of claim 10, wherein determining that the information encoded by the machine-readable identifier, when decoded, is missing certain information for the particular field of the one or more input fields includes:
determining that the certain information is not included with the particular classification of documents,
wherein the prompt is a graphical user interface (GUI) prompt includes natural language content that is associated with the certain information not included with the particular classification of documents.

12. The method of claim 11, wherein causing the prompt to be rendered for directing the user to provide the certain information for completing the particular field of the one or more input fields includes:
causing the GUI prompt to be rendered with other content that identifies a separate classification of documents,
wherein the separate classification of documents includes the certain information not included with the particular classification of documents.

13. The method of claim 9, wherein causing the prompt to be rendered for directing the user to provide the certain information for completing the particular field of the one or more input fields includes:
causing the prompt to be rendered as an audible output that solicits the user to provide the certain information via a spoken utterance to an audio interface of the computing device or the separate computing device.

14. The method of claim 13, further comprising:
receiving, from the user and in response to causing the prompt to be rendered, a particular spoken utterance that embodies additional information for completing the particular field of the one or more input fields; and
causing, in response to receiving the spoken utterance, the additional information to be incorporated into the particular field of the one or more input fields according to a predefined format of the particular field.

15. A method implemented by one or more processors, the method comprising:
determining an identifier for a website that a user is accessing via a display interface of a computing device,
wherein the website includes a fillable form document that includes one or more input fields that are each configured to receive user input of a respective predefined format;
causing, based on the identifier for the website, an interface of the computing device or a separate computing device to render a prompt for directing the user to provide an image of a particular classification of informational document;
processing image data to extract information that is provided by the particular classification of informational document,
wherein the image data characterizes a particular image that is captured by a camera of the computing device or another computing device;
processing, based on the identifier for the website, at least a portion of the extracted information to convert at least the portion of the extracted information into a particular predefined format for a particular input field of the one or more input fields; and
causing, based on processing at least the portion of the extracted information, input data to be submitted to the particular input field of the fillable form document,
wherein the input data characterizes the portion of the information in the particular predefined format.

16. The method of claim 15, further comprising:
determining, based on processing the image data, that the user provided a particular image of a different classification of informational document; and
causing, based on processing the image data, a prompt to be rendered for directing the user to provide an additional image of the particular classification of informational document,
wherein the extracted information is from the additional image submitted by the user.

17. The method of claim 15, wherein processing at least the portion of the extracted information to convert at least the portion of the extracted information into the particular predefined format includes:
determining that the particular image includes a particular type of machine-readable identifier,
wherein at least the portion of the extracted information is converted into the particular predefined format based on the particular type of machine-readable identifier.

18. The method of claim 15, wherein the identifier for the website is a uniform resource locator (URL) or other uniform resource identifier (URI).

19. The method of claim 15, further comprising:
causing, based at least on the identifier for the website, the interface of the computing device or the separate computing device to render an additional prompt for directing the user to provide a textual input for completing at least one input field of the one or more input fields.

20. The method of claim 15, further comprising:
causing, based at least on the identifier for the website, the computing device or the separate computing device to render an audible prompt that directs the user to provide a spoken input for completing at least one input field of the one or more input fields.

21. (canceled)

22. (canceled)
